(19) United States
(12) Patent Application Publication
(10) Pub. No.: US 2026/0338949 A1
(43) Pub. Date: Oct. 29, 2026

(54) GRID-BASED ULTRASONIC SENSOR DATA PROCESSING SYSTEM

(71) Applicant: GM Global Technology Operations LLC, Detroit, MI (US)

(72) Inventors: Dan Levi, Ganei Tikvah (IL); Liran Malachi, Ra'anana (IL); Ariel Rubanenko, Hod Hasharon (IL); Limor Romano, Kiryat Bialik (IL); Alon Davidi, Herzelia (IL); Yinon Nave, Tel Aviv (IL)

(21) Appl. No.: 19/188,271

(22) Filed: Apr. 24, 2025

(51) Int. Cl. G01S 15/931; G01C 21/00

(52) U.S. Cl. CPC G01S 15/931; G01C 21/3807; G01C 21/3859; G01S 2015/932

(57) ABSTRACT

A grid-based ultrasonic sensor data processing system for an obstacle detection system in a vehicle includes a plurality of ultrasonic sensors and one or more controllers in electronic communication with the plurality of ultrasonic sensors. The one or more controllers include one or more processors that execute instructions to receive a return signal from a particular ultrasonic sensor. In response to receiving the return signal received by the particular ultrasonic sensor, the one or more controllers translate the return signal into an arc and plot the arc onto a grid-based ultrasonic data map. The one or more controllers employ a sliding window technique that shifts the plurality of cells relative to the ego position of the vehicle as the vehicle travels within the environment.

The present disclosure relates to a grid-based ultrasonic sensor data processing system that is part of an obstacle detection system for a vehicle. In embodiments, the obstacle detection system is a parking assistance system.

Parking assistance systems often employ ultrasonic sensors to detect the presence of obstacles that are located around a vehicle. The ultrasonic sensors may be placed along the front and/or rear bumper fascia of a vehicle and measure the distance to a target object by emitting ultrasonic sound waves.

Ultrasonic sensor data processing approaches rely upon the trilateration of consecutive echoes forming point clouds as well as clustering and extracting objects to build a map, which may exhibit limitations in accuracy when identifying target objects. Specifically, an ultrasonic sensor typically includes a conical field-of-view, where a beam angle or arc refers to a two-dimensional reprojection of the area included by the field-of-view. It is to be appreciated that when an obstacle is detected by an ultrasonic sensor, the object may be located anywhere along the length of the arc that defines the ultrasonic sensor’s field-of-view. In other words, the ultrasonic sensor determines the presence of an obstacle along the arc, but the exact position along the length of the arc where the obstacle is actually located is unknown. As a result, when employed in environments such as an underground parking garage or a crowded parking lot, current parking assistance systems may not always be able to detect pillars, accurately identify vehicles, and are susceptible to noise, which may lead to false object creation.

Thus, while current parking assistance systems achieve their intended purpose, there is a need in the art for an improved approach for processing ultrasonic sensor data.

### SUMMARY

According to several aspects, A grid-based ultrasonic sensor data processing system for an obstacle detection system in a vehicle including a plurality of ultrasonic sensors is disclosed. The grid-based ultrasonic sensor data processing system includes one or more controllers in electronic communication with the plurality of ultrasonic sensors. The one or more controllers include one or more processors that execute instructions to receive a return signal from a particular ultrasonic sensor, where the return signal is created as a transmit signal emitted from the particular ultrasonic sensor is reflected from an obstacle located within an environment surrounding the vehicle. In response to receiving the return signal received by the particular ultrasonic sensor, the one or more controllers translate the return signal into an arc and plot the arc onto a grid-based ultrasonic data map, wherein the grid-based ultrasonic data map plots a position of various obstacles located in the environment surrounding the vehicle relative to an ego position of the vehicle, and wherein the grid-based ultrasonic data map is divided into a plurality of cells arranged in a grid pattern. The one or more controllers employ a sliding window technique that shifts the plurality of cells relative to the ego position of the vehicle as the vehicle travels within the environment, and determine the position of the various obstacles located in the environment surrounding the vehicle relative to the ego position of the vehicle based on an individual weight value of each of the plurality of cells of the grid-based ultrasonic data map, wherein the individual weight value of each of the plurality of cells is determined based on a total number of arc points located within a particular cell.

In another aspect, the individual weight value of each of the plurality of cells is determined by calculating a total number of arc points located within each cell, wherein each arc point is assigned a numerical value, and multiplying the total number of arc points within each cell by the numerical value assigned to the arc points.

In yet another aspect, each arc plotted on the grid-based ultrasonic data map includes a plurality of arc points that are spaced equidistant from one another along an entire arc length.

In an aspect, the position of the various obstacles located in the environment surrounding the vehicle is determined by comparing the individual weight value for each of the plurality of cells with a threshold weight value, and in response to determining the individual weight value corresponding to an individual cell is equal to or greater than the threshold weight value, activate the individual cell, wherein activating the individual cell of the grid-based ultrasonic data map causes the arc points located within the individual cell to become active cells.

In another aspect, the position of the various obstacles located in the environment surrounding the vehicle is determined by executing one or more clustering algorithms upon the active cells within the grid-based ultrasonic data map to identify a specific obstacle located in the environment surrounding the vehicle.

In yet another aspect, the one or more clustering algorithms draw a bounding box around the arc points located within the active cells.

In an aspect, the bounding box marks and localizes the specific obstacle located in the environment.

In another aspect, each of the plurality of cells of the grid-based ultrasonic data map includes a maximum weight value.

In yet another aspect, the maximum weight value is 255.

In an aspect, the sliding window technique includes clearing a column of cells that are positioned along a trailing edge of the grid-based ultrasonic data map as the ego position of the vehicle advances along the grid-based ultrasonic data map in the direction of travel while simultaneously introducing a new column of cells that are positioned along a leading edge of the grid-based ultrasonic data map.

In another aspect, the leading edge represents a column of cells disposed towards the direction of travel of the ego position of the vehicle and the trailing edge of the grid-based ultrasonic data map represents a column of cells that are disposed opposite from the direction of travel of the ego position of the vehicle.

In yet another aspect, the plurality of cells cooperate together to create a fixed mapping area that represents a portion of the environment surrounding the vehicle.

In an aspect, the plurality of cells are arranged into a plurality of columns and a plurality of rows.

In another aspect, the obstacle detection system is a parking assistance system.

In yet another aspect, a method for processing ultrasonic data by a grid-based ultrasonic sensor data processing system for an obstacle detection system in a vehicle including a plurality of ultrasonic sensors is disclosed. The method includes receiving, by one or more controllers, a return signal from a particular ultrasonic sensor, where the return signal is created as a transmit signal emitted from the particular ultrasonic sensor is reflected from an obstacle located within an environment surrounding the vehicle, and where the one or more controllers are in electronic communication with the plurality of ultrasonic sensors. In response to receiving the return signal received by the particular ultrasonic sensor, the method includes translating the return signal into an arc and plot the arc onto a grid-based ultrasonic data map, where the grid-based ultrasonic data map plots a position of various obstacles located in the environment surrounding the vehicle relative to an ego position of the vehicle, and where the grid-based ultrasonic data map is divided into a plurality of cells arranged in a grid pattern. The method includes employing a sliding window technique that shifts the plurality of cells relative to the ego position of the vehicle as the vehicle travels within the environment, and determining the position of the various obstacles located in the environment surrounding the vehicle relative to the ego position of the vehicle based on an individual weight value of each of the plurality of cells of the grid-based ultrasonic data map, where the individual weight value of each of the plurality of cells is determined based on a total number of arc points located within a particular cell.

In yet another aspect, a grid-based ultrasonic sensor data processing system for an obstacle detection system in a vehicle including a plurality of ultrasonic sensors is disclosed. The grid-based ultrasonic sensor data processing system includes one or more controllers in electronic communication with the plurality of ultrasonic sensors. The one or more controllers include one or more processors that execute instructions to receive a return signal from a particular ultrasonic sensor, where the return signal is created as a transmit signal emitted from the particular ultrasonic sensor is reflected from an obstacle located within an environment surrounding the vehicle. In response to receiving the return signal received by the particular ultrasonic sensor, the one or more controllers translate the return signal into an arc and plot the arc onto a grid-based ultrasonic data map, where the grid-based ultrasonic data map plots a position of various obstacles located in the environment surrounding the vehicle relative to an ego position of the vehicle, and where the grid-based ultrasonic data map is divided into a plurality of cells arranged in a grid pattern, and each arc plotted on the grid-based ultrasonic data map includes a plurality of arc points that are spaced equidistant from one another along an entire arc length. The one or more controllers employ a sliding window technique that shifts the plurality of cells relative to the ego position of the vehicle as the vehicle travels within the environment, and determine the position of the various obstacles located in the environment surrounding the vehicle relative to the ego position of the vehicle based on an individual weight value of each of the plurality of cells of the grid-based ultrasonic data map, wherein the individual weight value of each of the plurality of cells is determined based on a total number of arc points located within a particular cell, and wherein the individual weight value of each of the plurality of cells is determined by: calculating a total number of arc points located within each cell, wherein each arc point is assigned a numerical value, and multiplying the total number of arc points within each cell by the numerical value assigned to the arc points.

In another aspect, the position of the various obstacles located in the environment surrounding the vehicle is determined by comparing the individual weight value for each of the plurality of cells with a threshold weight value, and in response to determining the individual weight value corresponding to an individual cell is equal to or greater than the threshold weight value, activate the individual cell, wherein activating the individual cell of the grid-based ultrasonic data map causes the arc points located within the individual cell to become active cells.

In yet another aspect, the position of the various obstacles located in the environment surrounding the vehicle is determined by executing one or more clustering algorithms upon the active cells within the grid-based ultrasonic data map to identify a specific obstacle located in the environment surrounding the vehicle.

In an aspect, the one or more clustering algorithms draw a bounding box around the arc points located within the active cells.

In another aspect, the bounding box marks and localizes the specific obstacle located in the environment.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed grid-based ultrasonic sensor data processing system as part of a vehicle, where the grid-based ultrasonic sensor data processing system includes a plurality of ultrasonic sensors in electronic communication with one or more controllers, according to an exemplary embodiment;

FIG. 2 illustrates a grid-based ultrasonic data map that represents a top view of an environment surrounding the vehicle, according to an exemplary embodiment;

FIG. 3 is a diagram of an arc that represents a return signal generated by one of the ultrasonic sensors shown in FIG. 1, according to an exemplary embodiment; and

FIG. 4 is a diagram of a bounding box drawn around arc points within the grid-based ultrasonic data map, according to an exemplary embodiment.

### DETAILED DESCRIPTION

The following description is merely exemplary in nature and is not intended to limit the present disclosure, application, or uses.

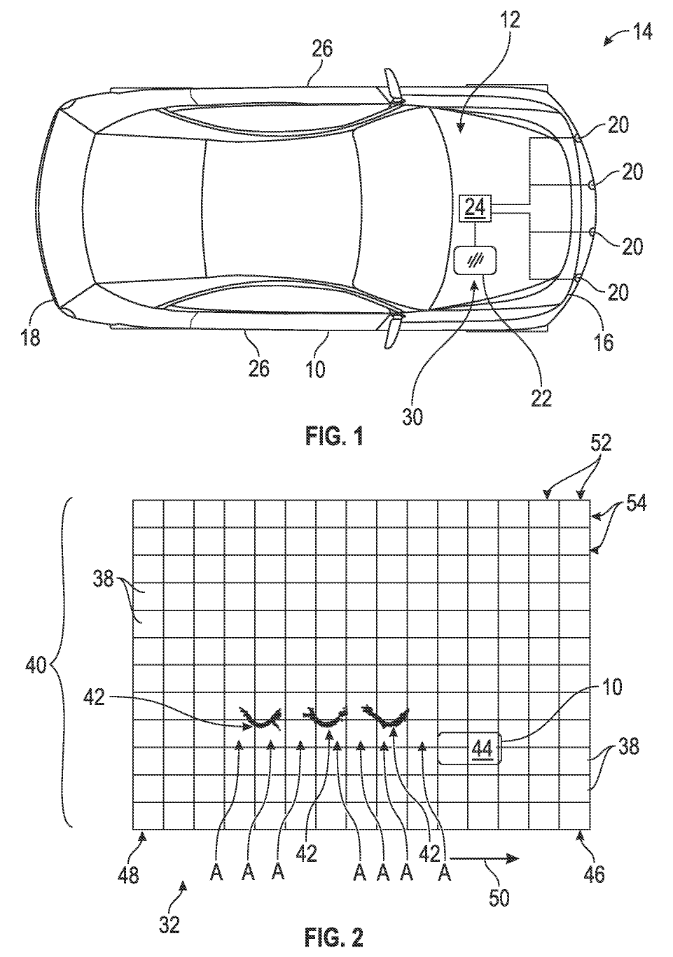

Referring to FIG. 1, schematic diagram of an exemplary vehicle 10 including a grid-based ultrasonic sensor data processing system 12 is illustrated. It is to be appreciated that the vehicle 10 may be any type of vehicle such as, but not limited to, a sedan, a truck, sport utility vehicle, van, or motor home. The grid-based ultrasonic sensor data processing system 12 includes a plurality of ultrasonic sensors 20 and a display 22 that are both in electronic communication with one or more controllers 24. In the non-limiting embodiment as illustrated in FIG. 1, the ultrasonic sensors 20 are disposed along a front bumper fascia 16 of the vehicle 10. However, it is to be appreciated that FIG. 1 is merely exemplary in nature and the ultrasonic sensors 20 may be disposed on other areas of the vehicle 10 as well such as, for example, the rear bumper fascia 18 of the vehicle 10 or the sides 26 of the vehicle 10 as well. Furthermore, in one non-limiting embodiment, the one or more controllers 24 are resource-constrained microcontrollers that include limited processing power and memory.

In one embodiment, the grid-based ultrasonic sensor data processing system 12 may be part of an object detection system 30 for the vehicle 10. The object detection system 30 generates a grid-based ultrasonic data map 32 (shown in FIG. 2) that represents a top view of the environment 14 surrounding the vehicle 10 based on ultrasonic data received from the plurality of ultrasonic sensors 20. The grid-based ultrasonic data map 32 may be shown upon the display 22 to one or more occupants of the vehicle 10. The display 22 may be any type of device for showing graphics and text such as, for example, light-emitting diode (LED) display, an organic LED (OLED) display, or a liquid crystal display (LCD).

One example of the object detection system 30 is a parking assistance system. For example, in one embodiment, the environment 14 surrounding the vehicle 10 may represent a parking lot or an underground parking garage. The ultrasonic data indicates the presence of obstacles located in the environment 14 surrounding the vehicle 10. In the present example, the obstacles would include the bumpers of surrounding vehicles and support pillars that are commonly found in underground parking garages. Although FIG. 1 illustrates the grid-based ultrasonic sensor data processing system 12 as part of a vehicle, it is to be appreciated that the grid-based ultrasonic sensor data processing system 12 may be used in other applications as well such as, for example, a robotic system.

Referring to FIG. 1, each of the ultrasonic sensors 20 emit a transmit signal. The transmit signal is an ultrasonic signal that is reflected by obstacles located within the environment 14. The distance between an obstacle and a particular ultrasonic sensor 20 is determined based on a time delay between a first point in time when the transmit signal is emitted by the particular ultrasonic sensor 20 and a second point in time when the particular ultrasonic sensor 20 receives a return signal. The return signal is a returning echo that is created as the transmit signal is reflected from an obstacle located within the environment 14 surrounding the vehicle 10.

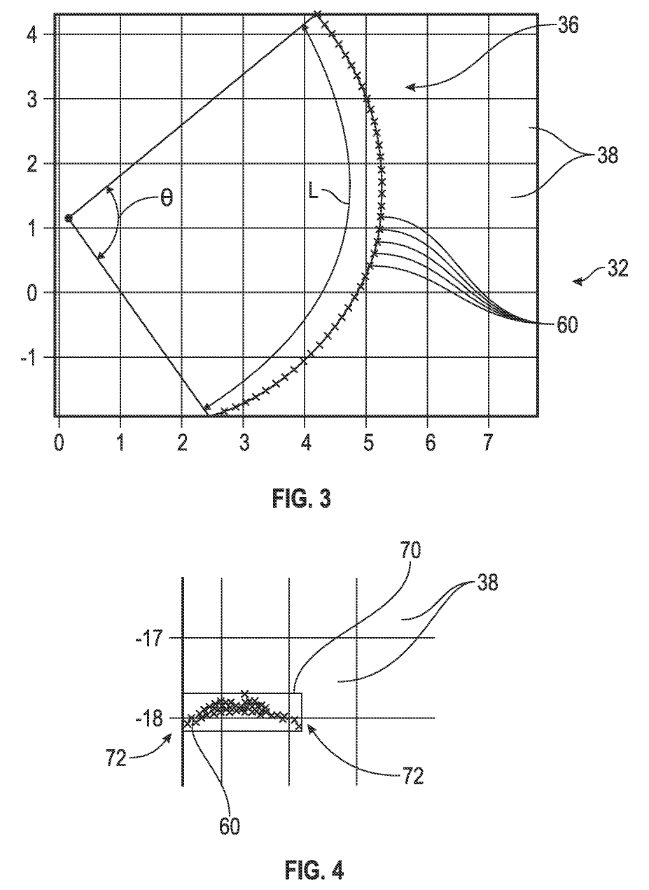

The return signal received by each of the ultrasonic sensors 20 is received by the one or more controllers 24. The one or more controllers 24 translate the return signal received by each of the ultrasonic sensors 20 into an arc 36 that is drawn upon the grid-based ultrasonic data map 32, which is shown in FIG. 3. FIG. 2 is an illustration of the entire grid-based ultrasonic data map 32, while FIG. 3 is an illustration of an individual arc 36 that is part of the grid-based ultrasonic data map 32 that has been translated from a return signal received by one of the ultrasonic sensors 20. Referring specifically to FIG. 2, the grid-based ultrasonic data map 32 plots the position of various obstacles 42 located in the environment 14 surrounding the vehicle 10 relative to an ego position 44 of the vehicle 10. In the example as shown in FIG. 2, the various obstacles 42 represent the rear bumpers of parked vehicles located in a parking lot, where the outline of the rear bumpers include a parabolic-shaped profile. The position of the various obstacles 42 are determined in real-time based on the return signals received by each of the plurality of ultrasonic sensors 20 over a period of time.

The grid-based ultrasonic data map 32 is divided into a plurality of cells 38 including an identical size and shape that are arranged in a grid pattern that includes a plurality of columns 52 and a plurality of rows 54. In the non-liming embodiment as shown in the figures, the cells 38 each include a square profile, however, it is to be appreciated that the cells 38 may include other profiles as well such as, for example, a rectangular profile. Each cell 38 represents an individual portion of the environment 14 surrounding the vehicle 10 (FIG. 1). Merely by way of example, in one embodiment each cell 38 of the grid-based ultrasonic data map 32 represents a 5 centimeter x 5 centimeter area of the environment 14. The plurality of cells 38 cooperate together to create a fixed mapping area 40 that represents a portion of the environment 14 surrounding the vehicle 10. In one non-limiting example, the fixed mapping area represents a portion of the environment 14 including dimensions of 20 meters x 20 meters, however, it is to be appreciated that the size of the fixed mapping area may depend upon the application.

Referring to FIGS. 1 and 2, it is to be appreciated that because the one or more controllers 24 may include limited processing power and memory, the environment 14 surrounding the vehicle 10 may be significantly larger than the fixed mapping area 40 that is represented by the plurality of cells 38 of the grid-based ultrasonic data map 32. Indeed, the size of the fixed mapping area 40 of the grid-based ultrasonic data map 32 is selected to ensure efficient utilization of the limited processing power and memory of the one or more controllers 24, while maintaining the ability to make updates in real-time. Furthermore, as explained below, the grid-based ultrasonic data map 32 also employs a sliding window technique that shifts the plurality of cells 38 relative to the ego position 44 of the vehicle 10 as the vehicle 10 travels within the environment 14, which also reduces the amount of processing and memory required by the one or more controllers 24.

Referring to FIGS. 1-3, each arc 36 (FIG. 3) includes an arc length L and an arc measure θ, where the arc length L represents a length of the arc 36 and the arc measure θ represents an angle subtended by the arc 36. The arc measure θ is measured in degrees or radians. In response to receiving the return signal received by a particular ultrasonic sensor 20, the one or more controllers 24 may first initialize the grid-based ultrasonic data map 32 by clearing any preexisting data from the plurality of cells 38. The one or more controllers 24 then translate the return signal into an arc 36 that is expressed in a map coordinate system of the grid-based ultrasonic data map 32 and then plots the arc 36 onto the grid-based ultrasonic data map 32.

Referring specifically to FIG. 2, the grid based-based ultrasonic map 32 includes a leading edge 46 of cells 38 and a trailing edge 48 of cells 38, where the leading edge 46 and the trailing edge 48 of the grid-based ultrasonic data map 32 are determined based on a direction of travel of the ego position 44 of the vehicle 10. Specifically, the leading edge 46 represents a column 52 of cells 38 disposed towards the direction of travel of the ego position 44 of the vehicle 10, while the trailing edge 48 of the grid-based ultrasonic data map 32 represents a column 52 of cells that are disposed opposite from the direction of travel of the ego position 44 of the vehicle 10. For example, the direction of travel of the ego position 44 of the vehicle 10 is from left to right, which is shown by an arrow 50 in FIG. 2. Accordingly, the leading edge 46 of the grid-based ultrasonic data map 32 is situated along a right-most column 52 of cells 38 while the trailing edge 48 of the grid-based ultrasonic data map 32 is situated along a left-most column 52 of cells 38.

As mentioned above, the one or more controllers 24 employ the sliding window technique to shift the position of the plurality of cells 38 relative to the ego position 44 of the vehicle 10 as the vehicle 10 travels within the environment 14. Specifically, the sliding window technique includes clearing a column 52 of cells 38 that are positioned along a trailing edge 48 of the grid-based ultrasonic data map 32 as the ego position 44 of the vehicle 10 advances along the grid-based ultrasonic data map 32 in the direction of travel while simultaneously introducing a new column 52 of cells that are positioned along a leading edge 46 of the grid-based ultrasonic data map 32. Accordingly, the total number of cells 38 and the fixed mapping area 40 of the grid-based ultrasonic data map 32 always remains constant.

Referring to FIGS. 1-3, the one or more controllers 24 generate the grid-based ultrasonic data map 32 by plotting the position of various obstacles 42 located in the environment 14 surrounding the vehicle 10 relative to the ego position 44 of the vehicle 10 based on an individual weighted value of each of the plurality of cells 38 of the grid-based ultrasonic data map 32, where the individual weight value of each of the plurality of cells 38 is determined based on a total number of arc points 60 (FIG. 3) located within a particular cell 38. Specifically, as seen in FIG. 3, each arc 36 includes a plurality of arc points 60 that are spaced equidistant from one another along the entire arc length L. In one non-limiting embodiment, each arc point 60 is spaced one degree apart. For example, an arc 36 including an arc measure θ of 120 degrees would include 120 individual arc points 60 spaced one degree apart from one another.

Determining the individual weight value for each cell 38 that is part of the grid-based ultrasonic data map 32 shall now be described. Specifically, the one or more controllers 24 determine the individual weight value for each cell 38 of the grid-based ultrasonic data map 32 by first calculating the total number of arc points 60 located within each cell 38, where each arc point 60 is assigned a numerical value. The one or more controllers 24 calculate the individual weight value for each cell 38 by multiplying the total number of arc points 60 within each cell 38 by the numerical value assigned to the arc points 60. Merely by way of example, in one embodiment if there are twelve points located in a particular cell 38 and if the numerical value is ten, then the individual weight value for the particular cell 38 is one hundred and twenty. It is to be appreciated that the individual weight value of a particular cell 38 represents the intensity of the number of return signals (i.e., the returning echoes) that are created as the transmit signals are reflected from obstacles in the environment 14. In other words, the grid-based ultrasonic data map 32 represents a heatmap that plots the intensity of the number of return signals located in a particular area of the environment.

Each cell 38 of the grid-based ultrasonic data map 32 may include a maximum weight value. Once the individual weight value of an individual cell 38 is equal to or greater than the maximum weight value, then the individual weight value of the individual cell 38 stays at the maximum weight value. In one non-limiting embodiment, the maximum weight value is 255, however, it is to be appreciated that other values that are based on the power of two may be used as well. The power of two may be expressed as 2ⁿ, where n represents an integer.

Continuing to refer to FIGS. 1-3, the one or more controllers 24 determine the position of various obstacles 42 located in the environment 14 surrounding the vehicle 10 relative to the ego position 44 of the vehicle 10 by comparing the individual weight value for each of the plurality of cells 38 with a threshold weight value. The threshold weight value is selected to indicate the presence of an obstacle within the individual portion of the environment 14 surrounding the vehicle 10 represented by a particular cell 38. In one embodiment, the threshold weight value is determined empirically to determine the presence of an obstacle with a predefined level of accuracy.

In response to determining the individual weight value corresponding to an individual cell 38 is equal to or greater than the threshold weight value, the one or more controllers 24 activate the individual cell 38. In the embodiment as shown in FIG. 2, the individual cells 38 that are activated are marked with the letter ‘A’. As seen in FIG. 2, activating the individual cell 38 of the grid-based ultrasonic data map 32 causes the arc points 60 located within the individual cell 38 to become active cells 38. As explained below, the one or more controllers 24 then execute one or more clustering algorithms upon the active cells 38 within the grid-based ultrasonic data map 32, where the clustering algorithms define the various obstacles 42 within the environment 14. In contrast, in response to determining the individual weight value corresponding to an individual cell 38 is less than the threshold weight value, the one or more controllers 24 disregard or does not consider the arc points 60 located within the individual cell 38.

Referring to FIGS. 1, 2, and 4, the one or more controllers 24 may then execute the one or more clustering algorithms upon the active cells 38 within the grid-based ultrasonic data map 32 to identify a specific obstacle located in the environment 14 surrounding the vehicle 10. Specifically, as seen in FIG. 4, the one or more clustering algorithms may draw a bounding box 70 around the arc points 60 located within the active cells 38, where the bounding box 70 marks and localizes a specific obstacle located in the environment 14. In the embodiment as shown in FIG. 4, the bounding box 70 marks the active cells 38 that represent the rear bumper of a vehicle. Some examples of clustering algorithms that may be used to identify a specific obstacle include, but are not limited to, hierarchical clustering, k-means clustering, and model-based clustering. In one embodiment, the one or more controllers 24 may employ histogram data to identify corners 72 where the sides of the specific object terminate.

Referring to FIGS. 1 and 2, in one embodiment, the one or more controllers 24 instruct the display 22 to show the grid-based ultrasonic data map 32 to one or more occupants of the vehicle 10. If the vehicle 10 includes autonomous or semiautonomous driving capabilities, then the one or more controllers 24 may instruct an autonomous driving system to navigate the vehicle 10 based on the various obstacles identified within the grid-based ultrasonic data map 32. Specifically, the autonomous driving system may instruct the vehicle 10 to avoid the various obstacles as the vehicle 10 as the vehicle 10 is navigated through an environment such as a parking lot. In the event that the grid-based ultrasonic sensor data processing system 12 is part of a parking assistance system, the parking assistance system may generate instructions or guidance to the driver of the vehicle 10 when performing a parking maneuver based on the various obstacles identified within the grid-based ultrasonic data map 32.

Referring generally to the figures, the disclosed grid-based ultrasonic sensor data processing system provides various technical effects and benefits. Specifically, the grid-based ultrasonic sensor data processing system creates a grid-based ultrasonic data map representing a heatmap that illustrates the intensity of the echo signals that are created as ultrasonic signals reflect from obstacles in the environment surrounding the vehicle. The grid-based ultrasonic sensor data system does not require tracker-based algorithms, unlike current ultrasonic data processing approaches. Furthermore, the grid-based ultrasonic sensor data system provides enhanced accuracy when detecting objects and requires less processing power and memory when compared to current ultrasonic data processing approaches.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A grid-based ultrasonic sensor data processing system for an obstacle detection system in a vehicle including a plurality of ultrasonic sensors, the grid-based ultrasonic sensor data processing system comprising:
one or more controllers in electronic communication with the plurality of ultrasonic sensors, wherein the one or more controllers include one or more processors that execute instructions to:
receive a return signal from a particular ultrasonic sensor, wherein the return signal is created as a transmit signal emitted from the particular ultrasonic sensor is reflected from an obstacle located within an environment surrounding the vehicle;
in response to receiving the return signal received by the particular ultrasonic sensor, translate the return signal into an arc and plot the arc onto a grid-based ultrasonic data map, wherein the grid-based ultrasonic data map plots a position of various obstacles located in the environment surrounding the vehicle relative to an ego position of the vehicle, and wherein the grid-based ultrasonic data map is divided into a plurality of cells arranged in a grid pattern;
employ a sliding window technique that shifts the plurality of cells relative to the ego position of the vehicle as the vehicle travels within the environment; and
determine the position of the various obstacles located in the environment surrounding the vehicle relative to the ego position of the vehicle based on an individual weight value of each of the plurality of cells of the grid-based ultrasonic data map, wherein the individual weight value of each of the plurality of cells is determined based on a total number of arc points located within a particular cell.

2. The grid-based ultrasonic sensor data processing system of claim 1, wherein the individual weight value of each of the plurality of cells is determined by:
calculating a total number of arc points located within each cell, wherein each arc point is assigned a numerical value; and
multiplying the total number of arc points within each cell by the numerical value assigned to the arc points.

3. The grid-based ultrasonic sensor data processing system of claim 2, wherein each arc plotted on the grid-based ultrasonic data map includes a plurality of arc points that are spaced equidistant from one another along an entire arc length.

4. The grid-based ultrasonic sensor data processing system of claim 1, wherein the position of the various obstacles located in the environment surrounding the vehicle is determined by:
comparing the individual weight value for each of the plurality of cells with a threshold weight value; and
in response to determining the individual weight value corresponding to an individual cell is equal to or greater than the threshold weight value, activate the individual cell, wherein activating the individual cell of the grid-based ultrasonic data map causes the arc points located within the individual cell to become active cells.

5. The grid-based ultrasonic sensor data processing system of claim 4, wherein the position of the various obstacles located in the environment surrounding the vehicle is determined by:
executing one or more clustering algorithms upon the active cells within the grid-based ultrasonic data map to identify a specific obstacle located in the environment surrounding the vehicle.

6. The grid-based ultrasonic sensor data processing system of claim 5, wherein the one or more clustering algorithms draw a bounding box around the arc points located within the active cells.

7. The grid-based ultrasonic sensor data processing system of claim 6, wherein the bounding box marks and localizes the specific obstacle located in the environment.

8. The grid-based ultrasonic sensor data processing system of claim 1, wherein each of the plurality of cells of the grid-based ultrasonic data map include a maximum weight value.

9. The grid-based ultrasonic sensor data processing system of claim 8, wherein the maximum weight value is 255.

10. The grid-based ultrasonic sensor data processing system of claim 1, wherein the sliding window technique includes:
clearing a column of cells that are positioned along a trailing edge of the grid-based ultrasonic data map as the ego position of the vehicle advances along the grid-based ultrasonic data map in the direction of travel while simultaneously introducing a new column of cells that are positioned along a leading edge of the grid-based ultrasonic data map.

11. The grid-based ultrasonic sensor data processing system of claim 10, wherein the leading edge represents a column of cells disposed towards the direction of travel of the ego position of the vehicle and the trailing edge of the grid-based ultrasonic data map represents a column of cells that are disposed opposite from the direction of travel of the ego position of the vehicle.

12. The grid-based ultrasonic sensor data processing system of claim 1, wherein the plurality of cells cooperate together to create a fixed mapping area that represents a portion of the environment surrounding the vehicle.

13. The grid-based ultrasonic sensor data processing system of claim 1, wherein the plurality of cells are arranged into a plurality of columns and a plurality of rows.

14. The grid-based ultrasonic sensor data processing system of claim 1, wherein the obstacle detection system is a parking assistance system.

15. A method for processing ultrasonic data by a grid-based ultrasonic sensor data processing system for an obstacle detection system in a vehicle including a plurality of ultrasonic sensors, the method comprising:
receiving, by one or more controllers, a return signal from a particular ultrasonic sensor, wherein the return signal is created as a transmit signal emitted from the particular ultrasonic sensor is reflected from an obstacle located within an environment surrounding the vehicle, wherein the one or more controllers are in electronic communication with the plurality of ultrasonic sensors;
in response to receiving the return signal received by the particular ultrasonic sensor, translating the return signal into an arc and plot the arc onto a grid-based ultrasonic data map, wherein the grid-based ultrasonic data map plots a position of various obstacles located in the environment surrounding the vehicle relative to an ego position of the vehicle, and wherein the grid-based ultrasonic data map is divided into a plurality of cells arranged in a grid pattern;
employing a sliding window technique that shifts the plurality of cells relative to the ego position of the vehicle as the vehicle travels within the environment; and
determining the position of the various obstacles located in the environment surrounding the vehicle relative to the ego position of the vehicle based on an individual weight value of each of the plurality of cells of the grid-based ultrasonic data map, wherein the individual weight value of each of the plurality of cells is determined based on a total number of arc points located within a particular cell.

16. A grid-based ultrasonic sensor data processing system for an obstacle detection system in a vehicle including a plurality of ultrasonic sensors, the grid-based ultrasonic sensor data processing system comprising:
one or more controllers in electronic communication with the plurality of ultrasonic sensors, wherein the one or more controllers include one or more processors that execute instructions to:
receive a return signal from a particular ultrasonic sensor, wherein the return signal is created as a transmit signal emitted from the particular ultrasonic sensor is reflected from an obstacle located within an environment surrounding the vehicle;
in response to receiving the return signal received by the particular ultrasonic sensor, translate the return signal into an arc and plot the arc onto a grid-based ultrasonic data map, wherein the grid-based ultrasonic data map plots a position of various obstacles located in the environment surrounding the vehicle relative to an ego position of the vehicle, and wherein the grid-based ultrasonic data map is divided into a plurality of cells arranged in a grid pattern, and each arc plotted on the grid-based ultrasonic data map includes a plurality of arc points that are spaced equidistant from one another along an entire arc length;
employ a sliding window technique that shifts the plurality of cells relative to the ego position of the vehicle as the vehicle travels within the environment; and
determine the position of the various obstacles located in the environment surrounding the vehicle relative to the ego position of the vehicle based on an individual weight value of each of the plurality of cells of the grid-based ultrasonic data map, wherein the individual weight value of each of the plurality of cells is determined based on a total number of arc points located within a particular cell, and wherein the individual weight value of each of the plurality of cells is determined by:
calculating a total number of arc points located within each cell, wherein each arc point is assigned a numerical value; and
multiplying the total number of arc points within each cell by the numerical value assigned to the arc points.

17. The grid-based ultrasonic sensor data processing system of claim 16, wherein the position of the various obstacles located in the environment surrounding the vehicle is determined by:
comparing the individual weight value for each of the plurality of cells with a threshold weight value; and
in response to determining the individual weight value corresponding to an individual cell is equal to or greater than the threshold weight value, activate the individual cell, wherein activating the individual cell of the grid-based ultrasonic data map causes the arc points located within the individual cell to become active cells.

18. The grid-based ultrasonic sensor data processing system of claim 17, wherein the position of the various obstacles located in the environment surrounding the vehicle is determined by:
executing one or more clustering algorithms upon the active cells within the grid-based ultrasonic data map to identify a specific obstacle located in the environment surrounding the vehicle.

19. The grid-based ultrasonic sensor data processing system of claim 18, wherein the one or more clustering algorithms draw a bounding box around the arc points located within the active cells.

20. The grid-based ultrasonic sensor data processing system of claim 19, wherein the bounding box marks and localizes the specific obstacle located in the environment.
